(19) United States
(12) Patent Application Publication
(10) Pub. No.: US 2007/0260730 A1
(43) Pub. Date: Nov. 8, 2007

(54) Automatically updated instant messaging (IM) presence of roaming IM user

(76) Inventor: Adithya Gadwale, Severna Park, MD (US)

Correspondence Address: MANELLI DENISON & SELTER PLLC, 7th Floor, 2000 M Street, N.W., Washington, DC, 20036-3307, US

(21) Appl. No.: 11/797,821

(22) Filed: May 8, 2007

Related U.S. Application Data
(60) Provisional application No. 60/798,331, filed on May 8, 2006.

(51) Int. Cl. G06F 15/173

(52) U.S. Cl. 709/224

(57) ABSTRACT

Constant availability and/or presence information of a roaming Instant Messaging (IM) user is provided. The invention recognizes that IM users are not always sitting at their computer where their IM client application is installed. Detection of an unrelated short-range wireless communication device, e.g., a Bluetooth cell phone, or an RFID, carried on the body of the IM user, is accomplished by other, local or guest computers, and reported as presence changes for that particular IM user to an IM server, that logs that IM user's presence in a suitable IM user presence database. Thus, a status or presence change is automatically updated in an IM server or other relevant IM application when a roaming IM user is in a vicinity of a guest computer at a different location.

This application claims priority from U.S. Provisional Application No. 60/798,331, entitled “Automatically Updated Instant Messaging (IM) Presence Based on Cell Vicinity to End User Computer”, to Adithya Gadwale, the entirety of which is expressly incorporated herein by reference.

### BACKGROUND OF THE INVENTION

1. Field of the Invention

The present invention relates to wireless communications in general. More particularly, it relates to Instant Messaging (IM) technology, and to presence information relating to an Instant Messaging user.

2. Background of the Related Art

Internet Relay Chat (IRC), ICQ, and Instant Messaging are digital techniques allowing users of computers to communicate textual messages to one another in a real-time environment.

IRC (“Internet Relay Chat”) is a system for chatting that involves a set of rules and conventions and client/server software. Unlike older chat systems, IRC is not limited to just two participants. Conventionally, an IRC client can be downloaded to a user's computer (e.g., PC or Palm Pilot™).

IRC is based on a client-server model, or network, as shown in FIG. 5. A user must connect to an IRC server in an IRC network to start or join an IRC chat group. As shown in FIG. 5, an IRC network is a collection of servers linked together. When you log onto an IRC network, you are connecting to one of the servers on that network. All servers on the IRC network share and have access to the same information. Thus, each server knows who is on the network, which chat rooms the users are currently in, and which servers the users are using as well.

Using IRC, a new chat group can be started, or an existing chat group can be joined. There is a protocol for discovering existing chat groups and their members. Perhaps the most common IRC networks are IRCnet (mostly European), Efnet (mostly North American), Undernet, and Dalnet. Popular IRC clients include mIRC for Windows, IRCle for MacOS, and irc2 (the original client) for UNIX-based operating systems.

The IRC protocol uses Transmission Control Protocol (TCP). TCP is a connection-oriented protocol used along with the Internet Protocol (IP) to send data in the form of message units between computers over the Internet. While IP takes care of handling the actual delivery of the data, TCP takes care of keeping track of the individual units of data (called packets) that a message is divided into for efficient routing through the Internet.

ICQ (“I Seek You”) is a program you can download that will let you know when friends and contacts are also online on the Internet, page them, and chat with them. In order to get maximum benefit from ICQ, both parties must have downloaded the ICQ program and have received a user identification number (UIN). The download and registration procedure are simple and enable you to send messages, files (single, multiple or whole directories), and URLs directly to your friends' desktops. In addition, you can initiate an IRC-style chat session or voice and video-voice connection and play games with other ICQ members that you are in touch with. Your contact is signaled of an incoming event as soon as it arrives and has immediate access to it.

Instant Messaging is a type of communications service that enables you to create a private chat room with another individual. Typically, an instant messaging system alerts you whenever somebody on your private list is online. You can then initiate a chat session with that particular individual.

Currently, there are several competing instant messaging systems, and no standard. Therefore, anyone a computer user would want to send an instant message to must use the same instant messaging system that the sender uses.

Instant Messaging (IM) users currently manually update their status and availability. However, the availability and presence information relating to a given IM user is often inaccurate. For instance, instant messages may be sent to users when they are not even physically available to receive messages. Moreover, Instant Messaging users can be reached at any time with a perceived location where they currently cannot be physically reached, e.g., when they carry a wireless device into a different office, etc.

Using current technology, users can manually change their status on Instant Messaging networks. Some conventional IM clients detect an absence of an IM user after no keyboard or mouse activity for an extended period of time, and thus change status of that IM user to “Away” or “Offline”. Users can manually login to IM networks for some cell phones and change their status while on the move.

Thus, current IM technology provides for manual status changes and manual presence information updates, or are based on physical contact of the user with their computer keyboard.

There is a need for more accurate and automated presence information with respect to an actual physical location of an Instant Messaging user.

### SUMMARY OF THE INVENTION

In accordance with the principles of the invention, a method and apparatus for automatically updating a presence status of a roaming Instant Messaging (IM) user comprises receiving presence information obtained by a first computer relating to detection of short-range communication between a short-range wireless device carried by the roaming IM user, and the first computer. A change of presence status for the roaming IM user is reported to an IM client application.

### BRIEF DESCRIPTION OF THE DRAWINGS

Features and advantages of the present invention will become apparent to those skilled in the art from the following description with reference to the drawings, in which:

FIG. 1 shows Instant Messaging presence tracking for a roaming IM user carrying a wireless communication device, in accordance with the principles of the present invention.

FIG. 2 depicts an IM user roaming about and passing within a vicinity of various local and/or guest computers, and out or short range communications with any local and/or guest computer, in accordance with the principles of the present invention.

FIG. 3 shows local and/or guest computers updating presence information on an IM server relating to the detected presence of a given IM user, in accordance with the principles of the present invention.

FIG. 4 shows various applications for automatically updated location presence for a roaming IM user, in accordance with the principles of the present invention.

FIG. 5 shows a conventional Internet Relay Chat (IRC)/instant Messaging (IM) group based on a client-server model, or network, wherein a user connects to an IRC server in an IRC network to start or join an IRC chat group (channel).

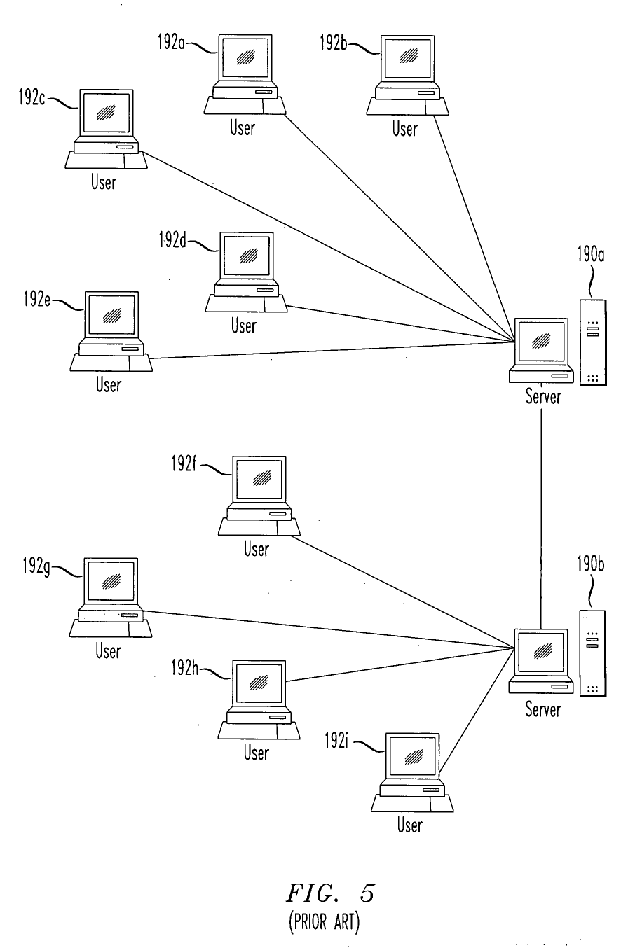

### DETAILED DESCRIPTION OF ILLUSTRATIVE EMBODIMENTS

This invention recognizes that IM users are not always sitting at their computer, i.e., where their IM client application is installed. In a home environment they might get up and walk about the house. In an office environment they might get up and walk about the office, go to lunch, etc. While away from the computer, the IM user will often miss IM messages. The sender will eventually detect that the IM user is ‘away’ from their desk by the conventional method of detecting the lack of manual keypresses on the keyboard of their computer.

The present invention implements detection of an unrelated wireless communication device on the body of the IM user by other, local or guest computers, and reporting of that detection of presence of the IM user to an IM server, that logs that IM user's presence in a suitable IM user presence database.

Exemplary unrelated wireless communication devices include a wireless phone (e.g., a cellular phone), and/or even a wireless radio frequency identification (RFID) device. RFID is an automatic identification method relying on storing and remotely retrieving data using RFID tags or transponders. An RFID tag is a small object that can be attached to or incorporated into a product, animal, or person. RFID tags contain silicon chips and antennas to enable them to receive and respond to radio frequency queries from an RFID transceiver. Passive RFID tags require no internal power source, while active RFID tags require a power source.

The present invention provides significant benefit to Instant Messaging users who also carry a wireless communication device such as a cell phone, or even a radio frequency identification (RFID) enabled card that can be communicated with via a wireless signal, and can even be extended to include benefit to professionals and/or office workers who require accurate presence information of other IM users.

In accordance with the principles of the present invention, a status or presence change is automatically updated in an IM server or other relevant IM application when a roaming IM user is in a vicinity of a guest computer at a different location. The term “roaming” as referred to in the present application refers to the physical movement of an IM user away from a computer (or computers) on which their IM client application is currently loaded.

In accordance with the principles of the present invention, detection is accomplished by communication between the IM user's short range RF communications capability of a cell phone (e.g., a Bluetooth communication) and a Bluetooth capable computer that is capable of communicating that presence information to an appropriate IM user presence database. Importantly, the wireless communication with which the IM user's presence is detected is accomplished using a short-range wireless communication technology such as Bluetooth or other piconet technology, and specifically NOT using the cellular RF front end of a cell phone, which is typically capable of communication over a distance of several miles.

Thus, a local and/or guest computer not currently running the roaming IM user's IM client application (with their particular screen name logged in) detects the passing IM user's presence either using Bluetooth™ or radio frequency identification (RFID) (or the computer detects the cell phone). Then, based on this automatic, short-range wireless detection of the roaming IM user's cell phone within range of a short-range wireless detection device on the local and/or guest computer (e.g., Bluetooth™ and/or RFID), the IM user's presence status information is reported to an appropriate IM server, which automatically updates the IM user presence database. If no local, guest computer is found in the vicinity of the IM user's short range wireless device (e.g., within range of a short range wireless device such as a Bluetooth device or an RFID device), the IM user's status is preferably changed to reflect the status of mobile cell messaging abilities.

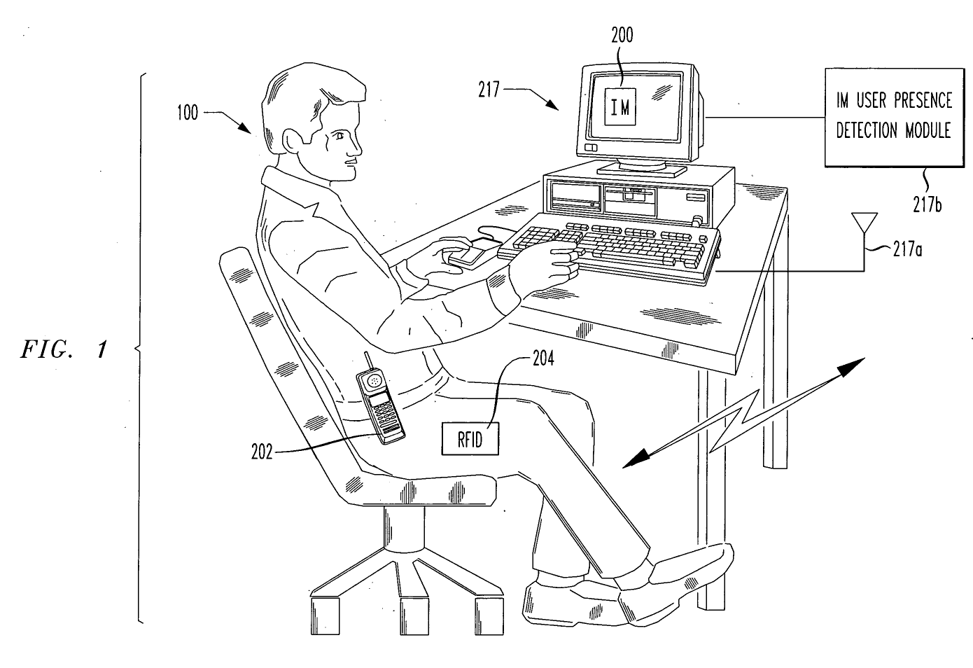

FIG. 1 shows Instant Messaging presence tracking for a roaming IM user carrying a wireless communication device, in accordance with the principles of the present invention.

In particular, as shown in FIG. 1, an IM user 100 enjoys a nice IM session 200 with one (or more) other IM users on a computer 217 having their IM client application loaded and logged in with their particular username and password entered. The IM user 100 has on their person one or more short-range wireless communication devices, e.g., a Bluetooth™ cell phone 202 and/or a radio frequency identification (RFID) tag 204.

In accordance with the principles of the present invention, the IM client application 200 residing in the IM user's computer 217 includes communication with a presence detection module 217b. The presence detection module 217b communicates with a short-range RF communications device in the computer 217 (e.g., a Bluetooth or other piconet wireless device) to determine what, if any, IM user(s) are within short-range wireless communications range of the computer 217. As shown in FIG. 1, the IM user presence detection module 217b determines by inference that the IM user 100 is present, as they are within the short-range wireless vicinity of the short-range RF antenna 217a associated with the computer 217.

The IM user presence detection module 217b reports to a relevant IM user presence database any status change of any/all IM user's within short-range wireless range. In the example of FIG. 1, the IM user presence detection module 217b reports that the particular IM user 100 is present at that computer 217.

The present invention allows IM users to move about, from office to office, building to building, etc., and have nearby guest/local computers automatically detect the IM user's presence, allowing other IM users access to that real-time presence information and send the IM user IM messages as desired at the computer within their vicinity.

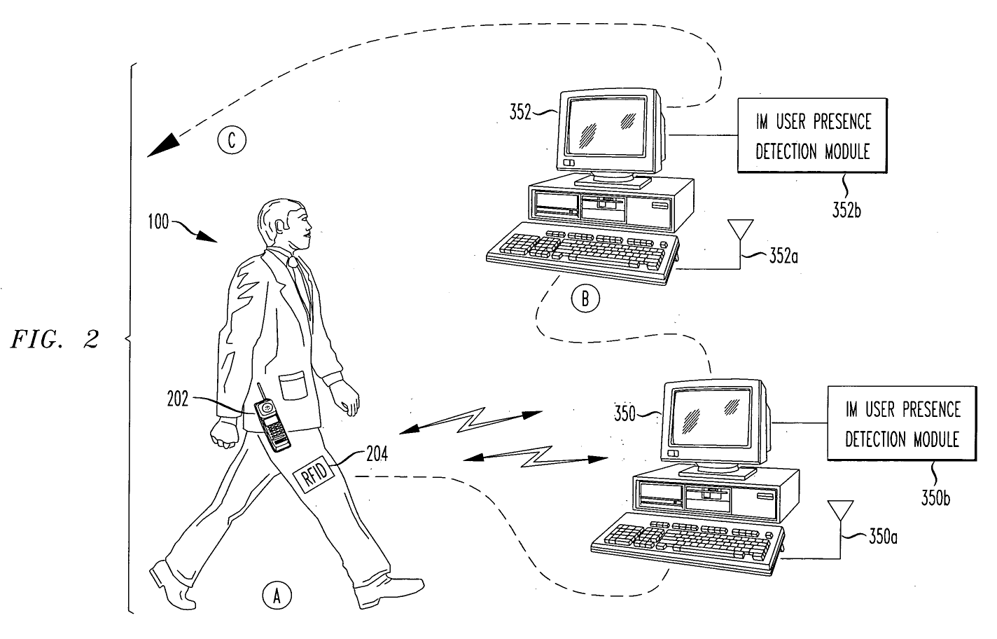

For instance, FIG. 2 depicts an IM user roaming about and passing within a vicinity of various local and/or guest computers, and out or short range communications with any local and/or guest computer, in accordance with the principles of the present invention.

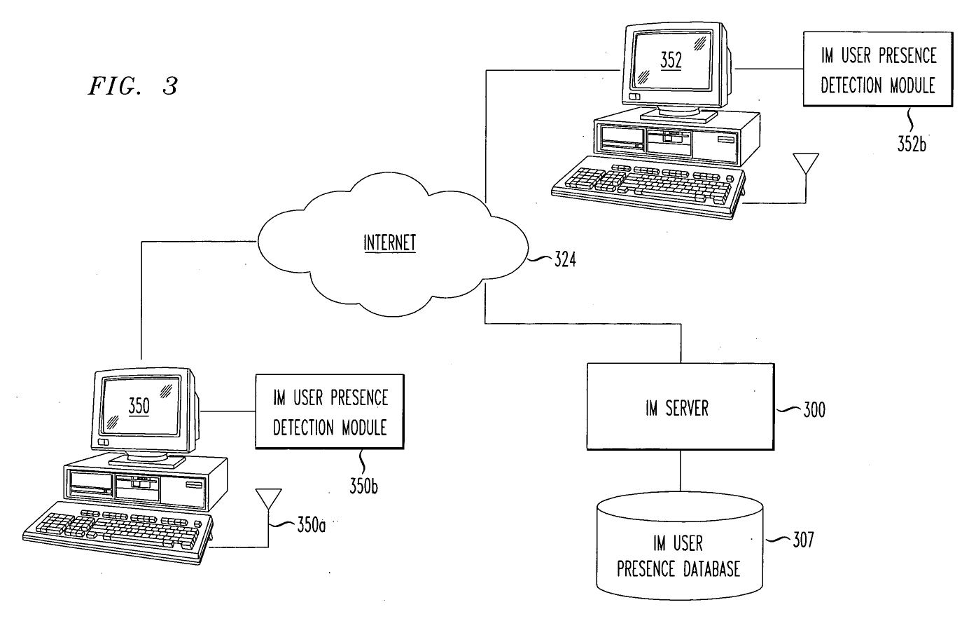

In particular, as shown in FIG. 2, an IM user 100 is walking about an office building (not shown). Importantly, the IM user 100 has on their person a short-range wireless communication device (202, 204). In the example shown in FIG. 2, the IM user 100 has both a Bluetooth cell phone 202 and an RFID device 204. The use of more than one short-range wireless communication device 202, 204 which can be used to detect presence of the IM user will only produce redundant presence reporting to an IM user presence database 307 (shown in FIG. 3). According to the invention, the IM user 100 need carry only one short-range wireless communication device on their person to allow for automatic presence reporting of a roaming IM user.

In the example shown in FIG. 2, the IM user 100 roams from location A, to location B, and eventually to location C. Location A places the IM user's short-range communication device(s) 202, 204 within range of the short-range communication device antenna 350b of a first local and/or guest computer 350. Once the roaming IM user 100 reaches point A, or more generally comes into range of short-range wireless communications with the computer 350, the associated IM user presence detection module 350b is informed of the current presence of the particular IM user 100. In turn, the IM user presence detection module 350b reports that IM user's presence, preferably together with date/time information, and further preferably along with an IP address of the computer 350 detecting the current presence of the roaming IM user 100. As a result, other IM users having compatible IM applications operating on their respective computer devices are then notified of the ‘online’ or similar status of the roaming IM user 100.

The other IM users need not be informed of the particular location of the roaming IM user 100. Rather, they need only be informed of the IP address of the computer 350 at which the particular IM user 100 is currently present at. In this way, otherwise ordinary IM communications may take place between the roaming IM user 100, via the nearby computer 350, and other IM users.

Then the IM user 100 begins to roam again, and sets out toward location B. On the way, at the point at which the IM user 100 roams outside the range of the first computer 350, the first computer 350 will detect the loss of short-range wireless communications with the roaming IM user 100, and will report the NOT present status to the IM user presence database 307 (FIG. 3).

Eventually, the IM user 100 roams and reaches location B. Location B places the IM user's short-range communication device(s) 202, 204 within range of the short-range communication device antenna 352b of a second local and/or guest computer 352. Once the roaming IM user 100 reaches point B, or more generally comes into range of short-range wireless communications with the computer 352, the associated IM user presence detection module 352b is informed of the current presence of the particular IM user 100. In turn, the IM user presence detection module 352b reports that IM user's presence, preferably together with date/time information, and further preferably along with an IP address of the computer 352 detecting the current presence of the roaming IM user 100. As a result, other IM users having compatible IM applications operating on their respective computer devices are then notified of the ‘online’ or similar status of the roaming IM user 100.

The other IM users need not be informed of the particular location of the roaming IM user 100. Rather, they need only be informed of the IP address of the computer 352 at which the particular IM user 100 is currently present at. In this way, otherwise ordinary IM communications may take place between the roaming IM user 100, via the nearby computer 352, and other IM users.

Then the IM user 100 begins to roam again, and sets out toward location C. On the way, at the point at which the IM user 100 roams outside the range of the second computer 352, the second computer 352 will detect the loss of short-range wireless communications with the roaming IM user 100, and will report the NOT present status to the IM user presence database 307 (FIG. 3).

Location C as shown in FIG. 2 is intended to represent a point outside short-range wireless communications of any relevant computer having an IM user presence detection module. As such, the IM user presence database 307 will show the roaming IM user 100 as being offline, away, or other similar nomenclature.

FIG. 3 shows local and/or guest computers updating presence information on an IM server relating to the detected presence of a given IM user, in accordance with the principles of the present invention.

In particular, as shown in FIG. 3, a plurality of local and/or guest computers 350, 352 have relevant IM applications running thereon, including associated IM user presence detection modules 350b, 352b, respectively. A networked IM server 300, accessed in the disclosed embodiments via the Internet 324, communicates with the operating IM user presence detection modules 350b, 352b, and automatically updates presence information relating to registered IM users in appropriate data entries in an appropriate IM user presence database 307.

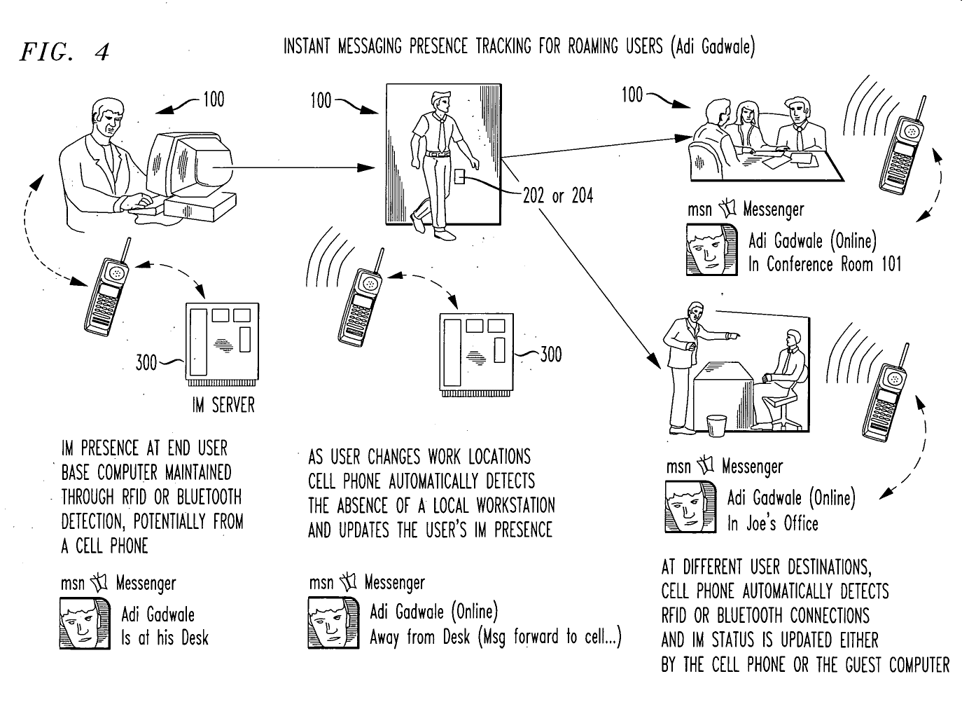

FIG. 4 shows various applications for automatically updated location presence for a roaming IM user, in accordance with the principles of the present invention.

In particular, as shown in FIG. 4, Instant Messaging (IM) services carry presence status information about their users. Presence status information refers herein to the user's availability, location, etc.

Exemplary presence status information on the inventive IM service may be, e.g., “Busy”, “Available”, “Offline”, “Out of the Office”, etc. These status indicators are such that they can be discerned from the wireless IM user's proximity (or lack thereof) to a networked wireless computer (i.e., local, guest computers).

In disclosed embodiments, Instant Messaging users carry an auxiliary short-range wireless communication device 202 or 204 unrelated to the IM messaging, e.g., a short-range wireless-capable cell phone 202 (e.g., a cell phone registered to, or otherwise associated with, that person), or even an RFID 204 (e.g., an RFID card associated with that person).

The IM user 100 isn't necessarily using the cell phone 202 to Instant Message, but rather, the IM client on a nearby computer merely tracks the presence of IM user(s) within range of a short range RF communication device in that nearby computer, and reports status changes to an IM user presence database. For instance, the IM client on a nearby computer detects the presence of a known IM user client and reports the same to an IM server 300 (FIG. 3) (based on an RFID chip or that person's cell phone being within wireless range of the short RF communications device.

Cell phones may communicate with the local and/or guest computer using Bluetooth™, piconet, or other short-range wireless technology or may simply be detected to be in the immediate vicinity of the local and/or guest computer using RFID. ID cards, employee IDs, and/or credit cards may contain RFID tags that can be detected by the local and/or guest computer.

When the IM user 100 is no longer in the vicinity of the local computer (either based on the detection (or lack thereof) of cell phone presence, RFID or Bluetooth™ communications, the change in status of the IM user's physical presence is preferably automatically updated for use by other relevant IM client(s) accordingly.

When the IM user 100 approaches a guest computer in a different physical location (e.g., as in a different office, or different conference room, or different building, etc.), the IM user's cell phone 202 may use its cellular network to communicate with the IM server, or the relevant guest computer may communicate with the IM server, to update IM presence status information using the same process as shown and described with respect to FIGS. 1-3.

The present invention provides constant availability and/or presence information for critical personnel to receive short, written, auditable communication (unlike voice calls). It also provides an ability to easily locate certain personnel when they are away from their desks.

The invention benefits from Instant Messaging users who carry cell phones or RFID enabled cards, and provides benefit to professionals and/or office workers who require accurate presence information of others.

In accordance with the principles of the present invention, services and products may include automatically updated presence information of an IM user based on cell phone capabilities or the presence of a computer in the vicinity.

While the invention has been described with reference to the exemplary embodiments thereof, those skilled in the art will be able to make various modifications to the described embodiments of the invention without departing from the true spirit and scope of the invention.

What is claimed is:

1. A method of automatically updating a presence status of a roaming Instant Messaging (IM) user, comprising:
receiving presence information obtained by a first computer relating to detection of short-range communication between a short-range wireless device carried by said roaming IM user, and said first computer; and
reporting a change of presence status for said roaming IM user to an IM client application.

2. The method of automatically updating a presence status of a roaming Instant Messaging (IM) user according to claim 1, further comprising:
facilitating Instant Messaging between another IM user at a second computer, and said roaming IM user at said first computer.

3. The method of automatically updating a presence status of a roaming Instant Messaging (IM) user according to claim 1, wherein:
said short range communication is a piconet network communication.

4. The method of automatically updating a presence status of a roaming Instant Messaging (IM) user according to claim 3, wherein:
said piconet network communication is a Bluetooth communication.

5. The method of automatically updating a presence status of a roaming Instant Messaging (IM) user according to claim 1, wherein:
said short-range wireless device is a cell phone.

6. The method of automatically updating a presence status of a roaming Instant Messaging (IM) user according to claim 5, wherein:
said cell phone is a Bluetooth cell phone.

7. The method of automatically updating a presence status of a roaming Instant Messaging (IM) user according to claim 1, wherein:
said short-range wireless device is a radio frequency identification (RFID) device.

8. The method of automatically updating a presence status of a roaming Instant Messaging (IM) user according to claim 1, wherein:
said roaming IM user is not logged into said first computer as an IM user at said first computer when said presence information is received.

9. The method of automatically updating a presence status of a roaming Instant Messaging (IM) user according to claim 1, further comprising:
automatically updating an IM user presence database in response to said receipt of said presence information obtained by said first computer.

10. Apparatus for automatically updating a presence status of a roaming Instant Messaging (IM) user, comprising:
means for receiving presence information obtained by a first computer relating to detection of short-range communication between a short-range wireless device carried by said roaming IM user, and said first computer; and
means for reporting a change of presence status for said roaming IM user to an IM client application.

11. The apparatus for automatically updating a presence status of a roaming Instant Messaging (IM) user according to claim 10, further comprising:
means for facilitating Instant Messaging between another IM user at a second computer, and said roaming IM user at said first computer.

12. The apparatus for automatically updating a presence status of a roaming Instant Messaging (IM) user according to claim 10, wherein:
said short range communication is a piconet network communication.

13. The apparatus for automatically updating a presence status of a roaming Instant Messaging (IM) user according to claim 12, wherein:
said piconet network communication is a Bluetooth communication.

14. The apparatus for automatically updating a presence status of a roaming Instant Messaging (IM) user according to claim 10, wherein:
said short-range wireless device is a cell phone.

15. The apparatus for automatically updating a presence status of a roaming Instant Messaging (IM) user according to claim 14, wherein:
said cell phone is a Bluetooth cell phone.

16. The apparatus for automatically updating a presence status of a roaming Instant Messaging (IM) user according to claim 10, wherein:
said short-range wireless device is a radio frequency identification (RFID) device.

17. The apparatus for automatically updating a presence status of a roaming Instant Messaging (IM) user according to claim 10, wherein:
said roaming IM user is not logged into said first computer as an IM user at said first computer when said presence information is received.

18. The apparatus for automatically updating a presence status of a roaming Instant Messaging (IM) user according to claim 10, further comprising:
automatically updating an IM user presence database in response to said receipt of said presence information obtained by said first computer.
